(19) United States
(12) Patent Application Publication
(10) Pub. No.: US 2005/0170859 A1
(43) Pub. Date: Aug. 4, 2005

(54) Information processing device

(75) Inventors: Atsushi Koike, Tokyo (JP); Katsuya Miyata, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/033,421

(22) Filed: Jan. 10, 2005

(30) Foreign Application Priority Data
Feb. 4, 2004 (JP) 2004-027866

(51) Int. Cl. H04M 1/00

(52) U.S. Cl. 455/550.1; 455/556.1; 455/417

(57) ABSTRACT

A handheld electronic device configured to be operated while being held on a user's hand including a first communication unit configured to transmit first data signals to a portable electronic device via a first communication link, the portable electronic device being configured to receive the first data signals from the handheld electronic device and generate sounds or images; a second communication unit configured to receive second data signals from a remote communication device via a second communication link, wherein the first data signals transmitted to the portable electronic device are generated using the second data signals received from the remote communication device; and a control unit configured to monitor a communication condition between the first communication unit and the portable electronic device as data signals are being received from the remote communication device via the second communication link. Termination of the second communication link is initiated if the communication condition is determined to be unsatisfactory.

### CROSS-REFERENCES TO RELATED APPLICATIONS

This application claims priority to Japanese Patent Application No. 2004-027866, filed on Feb. 4, 2004.

### BACKGROUND OF THE INVENTION

The present invention relates to an information processing device and, more particularly, to an information processing device that is able to communicate with remote wireless devices, the information processing device such as, for example, a mobile phone, personal handy-phone system (PHS), personal digital assistant (PDA), and personal computer (PC).

When a mobile phone is used with a headset that is wirelessly connected to the mobile phone, a method for making the user perceive the state of the mobile phone via the headset has heretofore been proposed (for example, JP-A No. 2002-10358).

However, the mobile phone described in the above JP-A No. 2002-10358 has no means to send a signal, depending on condition of communication between the mobile phone and the handset, to a remote wireless device to which the mobile phone connects via a network such as the Internet or a wireless telephone channel. Consequently, a problem results; for example, if the communication between the mobile phone and the headset becomes disabled when the user is listening to audio streams transmitted to the mobile phone with the headset wirelessly connected to the mobile phone, then the user can no longer hear the sound from the headset, but cannot stop the transmission of the audio streams to the mobile phone.

### BRIEF SUMMARY OF THE INVENTION

To solve the above problem and in accordance with one aspect of the present invention, there is provided an information processing device comprising a first communication means to communicate with a first remote wireless device, a second communication means to communicate with a second remote wireless device via a network, and a control means which performs a procedure for detecting communication condition for communication through the first communication means and a procedure for sending a request signal to the second remote wireless device, depending on the communication condition detected by the procedure for detecting communication condition.

The present invention in one aspect provides an information processing device comprising a first communication means to communicate with a first remote wireless device, a second communication means to communicate with a second remote wireless device via a network, and a control means which performs a procedure for detecting communication condition for communication through the first communication means and a procedure for sending a request signal to the second remote wireless device, depending on the communication condition detected by the procedure for detecting communication condition.

Another aspect of the present invention provides an information processing device comprising a first communication means to communicate with a first remote wireless device, a second communication means to communicate with a second remote wireless device via a network, a means for detecting remaining battery power of the first remote wireless device, and a control means which controls sending a request signal to the second remote wireless device, depending on the remaining battery power detected by the means for detecting remaining battery power.

The second remote wireless device may be a file server and the request signal may be a stop request signal to request the file server to stop transmitting a file. The second remote wireless device may be a telerecording device and the request signal may be a telerecording request signal to request the telerecording device to start telerecording. The second remote wireless device may be a telephone and the request signal may be an output request signal to request the telephone to output the communication condition. The second remote wireless device may be a telephone and the request signal may be a call disconnection request signal to request the telephone to disconnect the call, if the remaining battery power is exceedingly low. The above request signal may be an audio signal. The above first remote wireless device may be a headset.

Yet another aspect of the present invention is directed to an information processing device comprising a first communication means to communicate with a headset, a second communication means to communicate with a content distribution server which downloads content streams via a network, and a control means which performs a procedure for detecting communication condition for communication through the first communication means and a procedure for sending a request signal to stop stream download to the content distribution server, if the communication condition detected by the procedure for detecting communication condition is bad.

A further aspect of the present invention is directed to an information processing device comprising a first communication means to communicate with a headset, a second communication means to communicate with a corresponding mobile phone via a network, and a control means which performs a procedure for detecting communication condition for communication through the first communication means and a procedure for sending a request signal to the corresponding mobile phone to output the communication condition detected by the procedure for detecting communication condition to the corresponding mobile phone.

A still further aspect of the present invention is directed to an information processing device comprising a first communication means which transfers a broadcast being received from a broadcasting station to a headset, a second communication means to communicate with a server for recording current program which records a program broadcasted from the broadcasting station via a network, and a control means which performs a procedure for detecting communication condition for communication through the first communication means and a procedure for sending a request signal to record the broadcast being received to the server for recording current program, if the communication condition detected by the procedure for detecting communication condition is bad.

A yet further aspect of the present invention is directed to an information processing device comprising a first communication means to communicate with a first remote wireless device, a second communication means to communicate with a second remote wireless device via a network, and a control means which detects condition of communication through the first communication means and controls the second communication means to send a request signal to the second remote wireless device, depending on the detected communication condition.

In some implementations, the above control means detects the communication condition according to a rate of communication between the first remote wireless device and the first communication means.

### BRIEF DESCRIPTION OF THE DRAWINGS

FIG. 1 is a system configuration diagram in accordance with Embodiment 1;

FIG. 2 is a block diagram of a mobile phone according to Embodiment 1;

FIG. 3 is a block diagram of a headset according to Embodiment 1;

FIG. 4 is a flowchart illustrating an example of a processing flow that is performed by the control unit of the mobile phone in accordance with Embodiment 1;

FIG. 5 is an explanatory diagram showing a message example that is displayed on the display screen of the mobile phone in accordance with Embodiment 1;

FIG. 6 is a flowchart illustrating an example of a processing flow for determining whether communication is enabled in accordance with Embodiment 1;

FIG. 7 is a system configuration diagram in accordance with Embodiment 2;

FIG. 8 is a flowchart illustrating an example of a processing flow that is performed by the control unit of the mobile phone in accordance with Embodiment 2;

FIG. 9 is a system configuration diagram in accordance with Embodiment 3;

FIG. 10 is a block diagram of a mobile phone according to Embodiment 3; and

FIG. 11 is a flowchart illustrating an example of a processing flow that is performed by the control unit of the mobile phone in accordance with Embodiment 3.

### DETAILED DESCRIPTION OF THE INVENTION

The present invention is directed to an information processing device with enhanced usability.

According to one embodiment (Embodiment 1), a mobile phone with a headset wirelessly connected to it has the following capability. Suppose that its user is listening to audio streams transmitted from a content distribution server with the headset and, when the communication between the mobile phone and the headset experiences communication problems, the mobile phone will immediately send a predetermined stop request signal to the content distribution server to stop the transmission of the streams. The present mobile phone, thereby, can prevent the user from failing to hear the audio streams and enhance its usability.

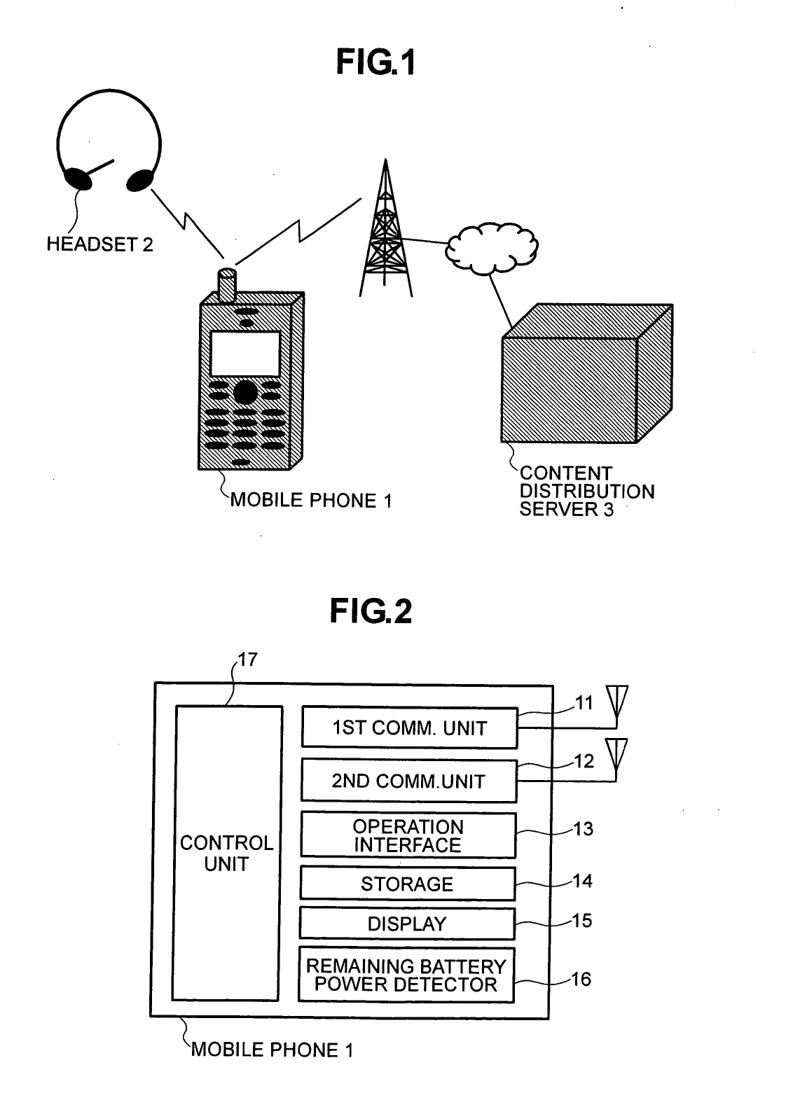

FIG. 1 is a schematic diagram showing a system configuration in which the mobile phone of Embodiment 1 operates. Reference numeral 1 denotes the mobile phone, 2 denotes the headset, and 3 denotes the content distribution server. By operating the mobile phone 1, the user can download streams of content from the content distribution server 3 and listen to the streams. Upon the download of the streams, video information is reproduced on the mobile phone 1 and audio information is transferred from the mobile phone 1 to the headset 2, which is reproduced by the headset 2.

To explain how the mobile phone of Embodiment 1 is configured, FIG. 2 which shows a block diagram of the mobile phone 1 of Embodiment 1 is provided. The mobile phone 1 is comprised of a first communication unit 11, a second communication unit 12, an operation interface 13, storage 14, a display 15, a remaining battery power detector 16, and a control unit 17.

The first communication unit 11 carries out communication with the headset 2 that is a first remote wireless device. Through the communication between the mobile phone 1 and the headset 2, information to be sent from the mobile phone 1 to the headset 2 includes audio streams, voice from the other end of a connected line, information indicating the internal state of the mobile phone 1, (e.g., radio conditions and remaining battery power), and user information stored in the mobile phone 1 (e.g., an address book). Information to be sent from the headset 2 to the mobile phone 2 includes information indicating the internal state of the headset 2 (e.g., radio conditions and remaining battery power) and user voice input via the headset 2.

The second communication unit 12 carries out communication with a second remote wireless device such as the content distribution server 3. Through the communication between the mobile phone 1 and the content distribution server 3, information to be sent from the mobile phone 1 to the content distribution server 3 includes a request to download streams and a request to stop streams. Information to be sent from the content distribution server 3 to the mobile phone 1 includes streams and streams-related information. The mobile phone structure example of FIG. 2 may be modified, such that the first communication unit 11 provides for two parallel communication channels and the mobile phone dispenses with the separate second communication unit 12.

The operation interface 13 handles inputs from the user of the mobile phone 1. The storage 14 stores programs, user information, information received by the first communication unit 11 and the second communication unit 12, information indicating the internal states of the mobile phone 1 and the headset 2, and others. The display 15 displays information received by the first communication unit 11 and the second communication unit 12, information retrieved from the storage 14, information that the user of the mobile phone 1 has entered via the operation interface 13, and others. The remaining battery power detector 16 detects the remaining battery power of the mobile phone 1. The control unit 17 exerts overall control of the mobile phone 1 and controls the above-mentioned components from the first communication unit 11 to the remaining battery power detector 16.

The information processing device of Embodiment 1 is not limited to the mobile phone and may be any other similar device having components corresponding to the above-mentioned components (the first communication unit 11 to the control unit 17).

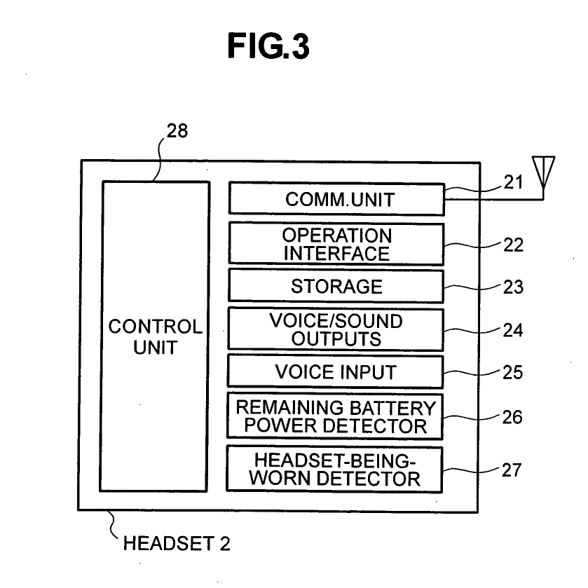

To give an example of how the headset of Embodiment 1 is configured, FIG. 3 which shows a block diagram of the headset 2 is provided. The headset 2 is used for the user by wearing it with its voice/sound outputs positioned at the ears and its voice input positioned at the mouth. The headset is comprised of a communication unit 21, an operation interface 22, storage 23, voice/sound outputs 24, a voice input 25, a remaining battery power detector 26, a headset-being-worn detector 27, and a control unit 28.

The communication unit 21 carries out communication with the mobile phone 1. The operation interface 22 handles inputs from the user of the headset 2. The storage 23 stores information received by the communication unit 21, information indicating the internal states of the mobile phone 1 and the headset 2, and others. The voice/sound outputs 24 output audio information received by the communication unit 21 and audio information retrieved from the storage 23. The voice input 25 handles voice input from the user of the headset 2. The remaining battery power detector 26 detects the remaining battery power of the headset 2. The headset-being-worn detector 27 determines whether or not the user is wearing the headset 2 properly. The control unit 28 provides overall control of the headset 2.

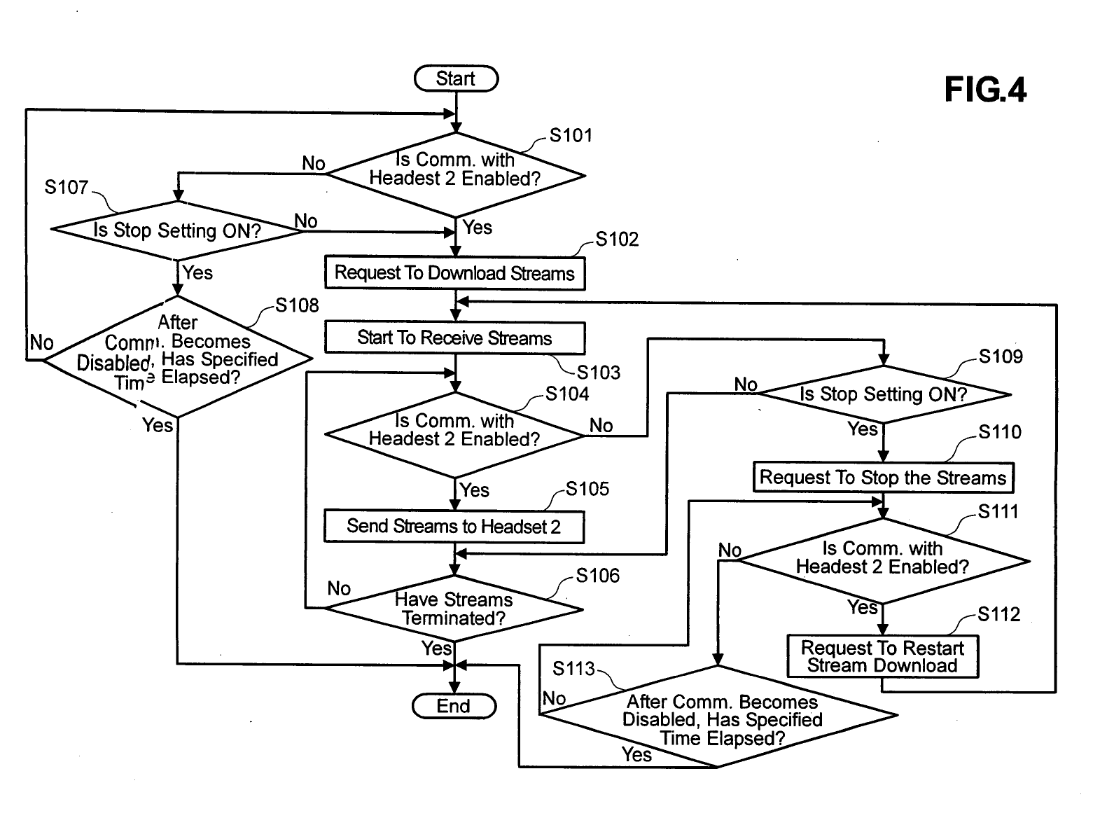

Now, an example of a processing flow that is performed by the mobile phone of Embodiment 1 is described. Using FIG. 4, how the mobile phone 1 carries out a procedure for an instance where the user wants to listen to audio streams through the mobile phone 1 and the headset 2 is explained. When the user of the mobile phone 1 submits a request to download streams, using the operation interface 13, the procedure starts and goes to step S101.

In step S101, the control unit 17 determines whether communication with the headset 2 is enabled. For example, if radio conditions are bad or if the remaining battery power of the headset 2 is exceedingly low, the control unit considers the communication to be disabled; otherwise, the control unit determines that the communication is enabled. By this determination, if the communication is disabled, then the procedure goes to step S107. If the communication is enabled, then the procedure goes to step S102.

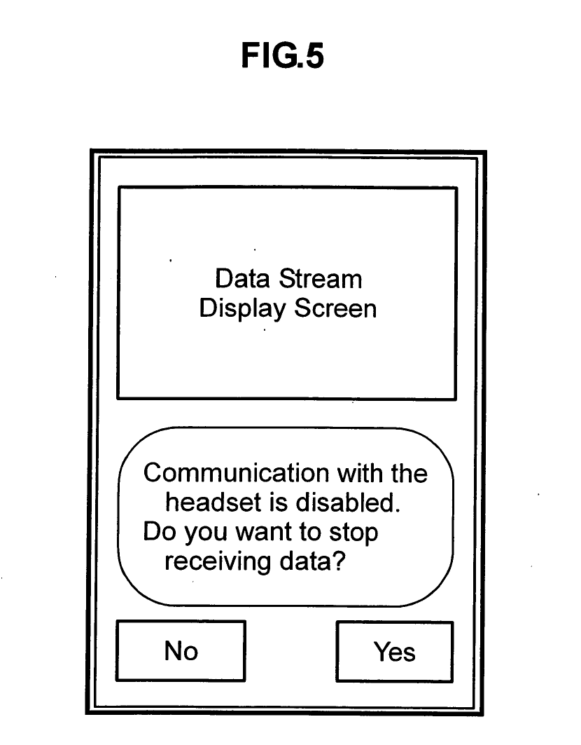

In step S107, the control unit 17 retrieves information as to whether ON or OFF has been set to stop the streams when the communication between the mobile phone 1 and the headset 2 is disabled or if this setting has not been set from the storage 14. If this setting has not been set, the control unit 17 causes the display 15 to display a message to prompt the user of the mobile phone 1 to select ON or OFF setting. An example of that message display is shown in FIG. 5. When the user of the mobile phone 1 selects ON or OFF setting, the control unit 17 obtains that the selected setting. If the selected setting is ON, then the procedure goes to step S108. If the setting is OFF, then the procedure goes to step S102.

In step S108, the control unit 17 checks to see whether specified time has elapsed after the communication between the mobile phone 1 and the headset 2 has become disabled. If the specified time has not elapsed, then the procedure returns to step S101 to determine again whether the communication is enabled. If the specified time has elapsed, then the procedure terminates.

In step S102, the control unit 17 sends the request to download streams through the second communication unit 12 to the content distribution server 3 and the procedure goes to step S103.

In step S103, the control unit 17 receives the streams transmitted from the content distribution server 3 through the second communication unit 12 and the procedure goes to step 104.

In step S104, the control unit 17 determines whether the communication with the headset 2 is enabled. This determination is made in the same manner as done in step 101. By this determination, if the communication is disabled, then the procedure goes to step S109. If the communication is enabled, then the procedure goes to step S105.

In step S105, the control unit 17 sends the streams through the first communication unit 11 to the headset 2, and the procedure goes to step S106.

In step S106, the control unit 17 checks to see whether the streams have terminated. If the streams have not terminated, then the procedure returns to step S104. If the streams have terminated, then the procedure terminates.

In step S109, the control unit 17 obtains information as to whether ON or OFF is the setting to stop the streams when the communication between the mobile phone 1 and the headset 2 is disabled. The setting information is obtained in the same manner as in step S107. If the setting is ON, then the procedure goes to step S110. If the setting is OFF, then the procedure returns to step S106.

In step S110, the control unit 17 sends a request to stop the streams through the second communication unit 12 to the content distribution server 3 and the procedure goes to step S111. At this time, if the mobile phone transmits audio streams to the headset 2, it stops the transmission.

In step S111, the control unit 17 determines whether the communication with the headset 2 is enabled. This determination is made in the same manner as in step S101. By this determination, if the communication is disabled, then the procedure goes to step S113. If the communication is enabled, then the procedure goes to step S112.

In step S112, the control unit 17 sends a request to restart the stream download through the second communication unit 12 to the content distribution server 3. For the request to restart the stream download, authentication and related data processing can be omitted, unlike the step S102 of the request to download streams. By sending information to specify the point of time when the streams stopped together with the request to restart the stream download, the stream download can restart from the stream stop point.

In step S113, the control unit 17 checks to see whether specified time has elapsed after the communication between the mobile phone 1 and the headset 2 has become disabled. If the specified time has not elapsed, then the procedure returns to step S111 to determine again whether the communication is enabled. If the specified time has elapsed, then the procedure terminates.

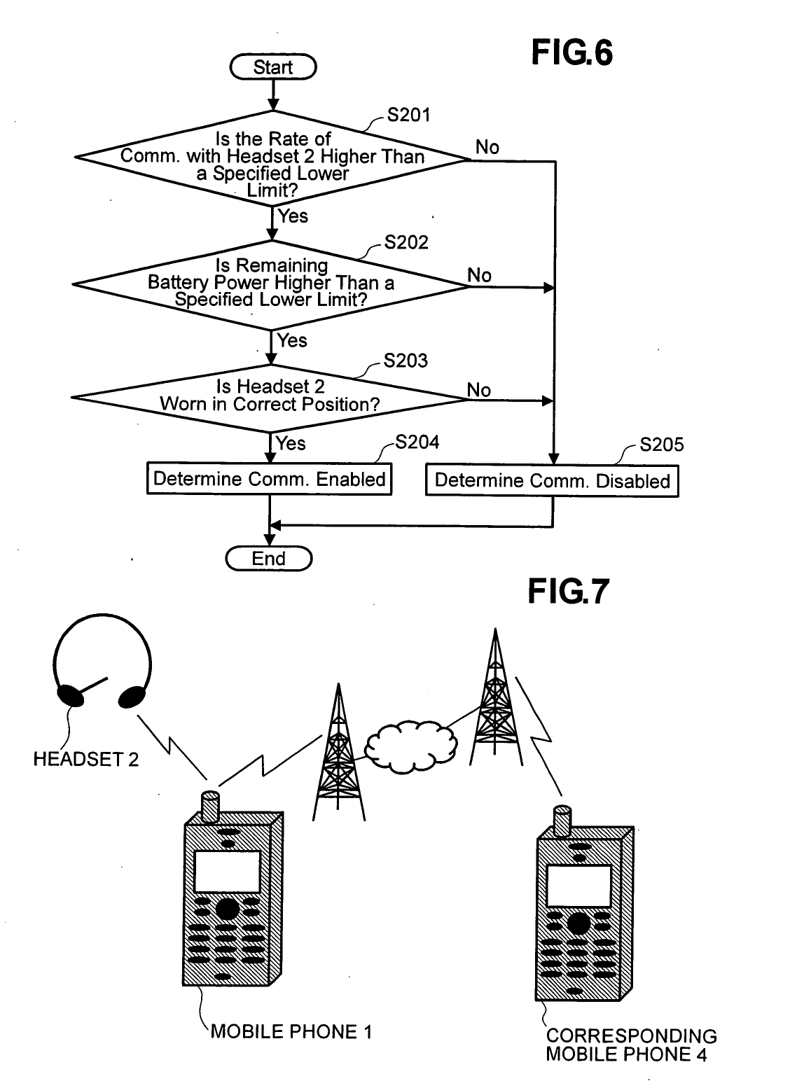

Next, using FIG. 6, a detailed procedure of determining whether the communication between the mobile phone 1 and the headset 2 is enabled, which is executed in the above steps S101, S104, and S111, is explained.

In step S201, the control unit 17 obtains information about the rate of the communication with the headset 2 through the first communication unit 11. Specifically, the communication rate can be known by calculation from the quantity of data per unit time sent to and received from the headset. Or a communication rate parameter may be exchanged between the mobile phone and the headset during the communication. If the communication with the headset 2 is impossible or if the communication rate is lower than a specified lower limit thereof, then the procedure goes to step S205 where the control unit determines the communication disabled. If not, the procedure goes to step S202.

In step S202, the control unit 17 of the mobile phone 1 requests the headset 2 to check the remaining battery power of the headset 2 through the first communication unit 11. Then, the control unit 28 of the headset 2 obtains information on the remaining battery power from the remaining battery power detector 26 and sends that information to the mobile phone 1 through the communication unit 21. If the remaining battery power of the headset 2 is lower than a specified lower limit (predefined value), then the procedure goes to step S205 where the control unit determines the communication to be disabled. If the remaining battery power of the headset 2 is lower than the specified lower limit, it is anticipated that the communication will become disabled shortly, but, as a result of the above determination, an early recharge before a battery shutoff can be performed. Thus, the user of the headset 2 can avoid not being able to hear the streams due to a batter shutoff. If the remaining battery power of the headset 2 is higher than the specified lower limit, the procedure goes to step S203.

In step S203, the control unit 17 of the mobile phone 1 requests the headset 2 to check to see whether the headset 2 is worn in a correct position through the first communication unit 11. Then, the control unit 28 of the headset 2 obtains information about the condition of the headset being worn from the headset-being-worn detector 27 and sends that information to the mobile phone 1 through the communication unit 21. One method in which the headset-being-worn detector 27 detects whether the headset is worn improperly is to measure the pressure with which the headset is pressed against the user's head, using a pressure sensor installed inside the headset. Upon the detection of a decrease in the pressure, the detector detects that the headset is not worn properly. If so, the procedure goes to step S205 where the control unit determines the communication to be disabled. Thus, the problem of not being able to hear the audio stream due to improperly wearing the headset can be prevented. If the headset 2 is worn properly, the procedure goes to step S204.

In step S204, the control unit 17 determines the communication to be enabled and the procedure terminates.

In step S205, the control unit 17 determines the communication disabled and the procedure terminates. At this time, the display screen of the mobile phone 1 may light up or the mobile phone may ring to signal the user of the mobile phone 1 that the stream download from the content distribution server is about to stop. The mobile phone's display may present an audio or text message like “communication with the headset is impossible” or “the headset battery will run out of power” to the user.

The flow of the processing steps shown in FIG. 6 is an example and the order of the steps S201 through S203 may change. A different criterion than the criteria of the decisions in the steps S201 through S203 may be used to determine the communication is disabled.

Another embodiment (Embodiment 2) of the present invention is described. In accordance with Embodiment 2, a mobile phone with a headset wirelessly connected to it has the following capability. Suppose that the mobile phone with the headset is connecting to a corresponding mobile phone and the mobile phone user converses with a person who uses the corresponding mobile phone and when the communication between the mobile phone and the headset experiences problems, the mobile phone will immediately send a predetermined signal to the corresponding mobile phone. Accordingly, the present mobile phone can inform the corresponding mobile phone user of the communication problem between the mobile phone and the headset, thereby enhancing its usability.

FIG. 7 is a schematic diagram showing a system configuration in which the mobile phone of Embodiment 2 operates. Both the components of a mobile phone 1 and the components of a headset 2 are the same as shown in the block diagrams of the mobile phone 1 and the headset 2 of Embodiment 1. However, the mobile phone of Embodiment 2 may be unable to receive audio streams and transfer them to the headset. A corresponding mobile phone 4 is assumed to be connected to the mobile phone 1, and the mobile phone 1 can communicate with the corresponding mobile phone 4 through the second communication unit 2.

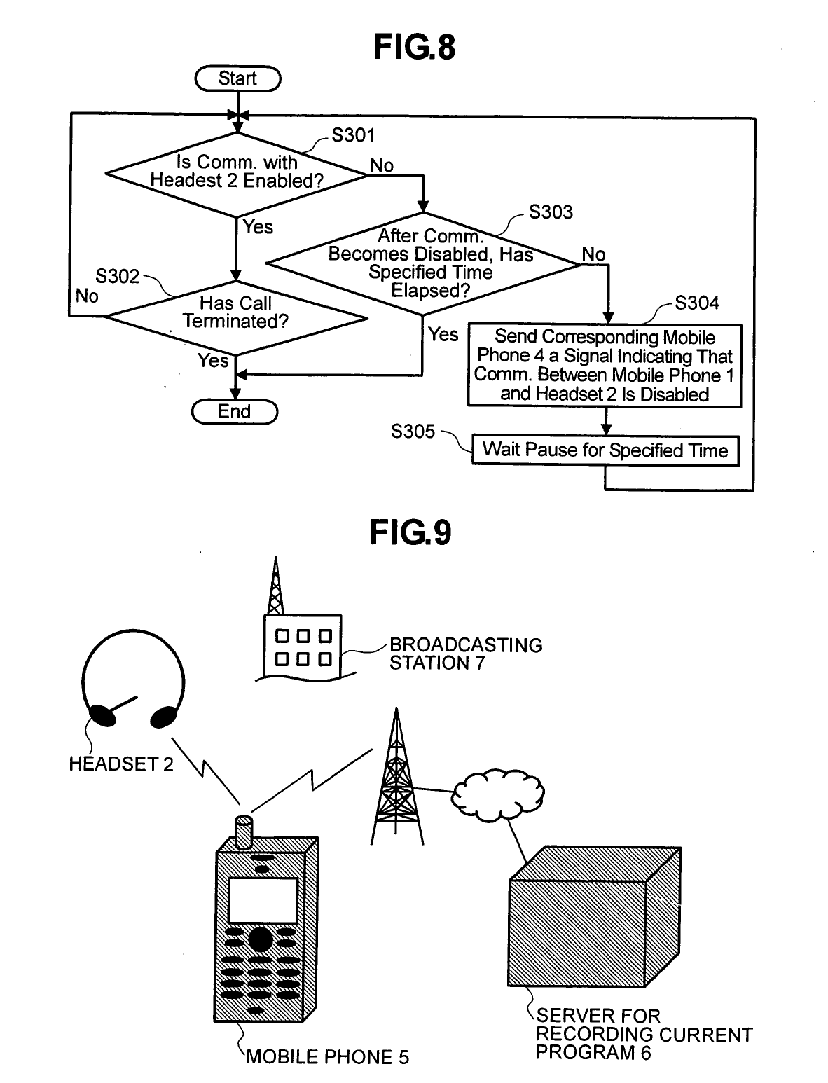

Now, an example of a processing flow that is performed by the mobile phone of Embodiment 2 is described. Using FIG. 8, how the mobile phone 1 carries out a procedure for making a call to another mobile phone is explained. When the user of the mobile phone 1 makes a call to another person's mobile phone by operating the operation interface 13 and begins conversion with him or her, the procedure starts and goes to step S301.

In step S301, the control unit 17 determines whether communication with the headset 2 is enabled. This determination is made in the same manner as described in Embodiment 1. However, audio information that is sent from the mobile phone 1 to the headset 2 is voice at the other end of the line, not audio streams. By this determination, if the communication is disabled, then the procedure goes to step S303. If the communication is enabled, then the procedure goes to step S302.

In step S303, the control unit 17 checks to see whether specified time has elapsed after the communication between the mobile phone 1 and the headset 2 becomes disabled. If the specified time has not elapsed, then the procedure goes to step S304. If the specified time has elapsed, then the procedure terminates.

In step S302, the control unit 17 checks to see whether the call has terminated. If the call has not terminated, then the procedure returns to step S301. If the call has terminated, then the procedure terminates.

In step S304, the control unit 17 sends a predetermined signal through the second communication unit 2 to the corresponding mobile phone 4 to signal the corresponding mobile phone 4 that the communication between the mobile phone 1 and the headset 2 is disabled and the procedure goes to step S305. Instead of this signal, an audio or text message like “the mobile phone to which you are connecting is now unable to communicate with its headset” may be sent to the corresponding mobile phone 4.

After the control unit 17 pauses for specified time in step S305, the procedure returns to step S301.

Yet another embodiment (Embodiment 3) of the present invention is described. In accordance with Embodiment 3, a mobile phone with a headset wirelessly connected to it has the following capability. Suppose that its user is receiving a broadcast with the headset and when the communication between the mobile phone and the headset experiences problems, the mobile phone will immediately send a predetermined request signal to record the broadcast program to a server for recording current program. As a result, the present mobile phone enables automatic recording of the program being received.

FIG. 9 is a schematic diagram showing a system configuration in which the mobile phone of Embodiment 3 operates. The components of a headset 2 are the same as shown in the block diagram of the headset 2 of Embodiment 1. A mobile phone 5 can receive a broadcast transmitted from a broadcasting station 7. The mobile phone 5 can communicate with a server for recording current program 6 and can send a request to record a program to the server for recording current program 6 (“server 6”).

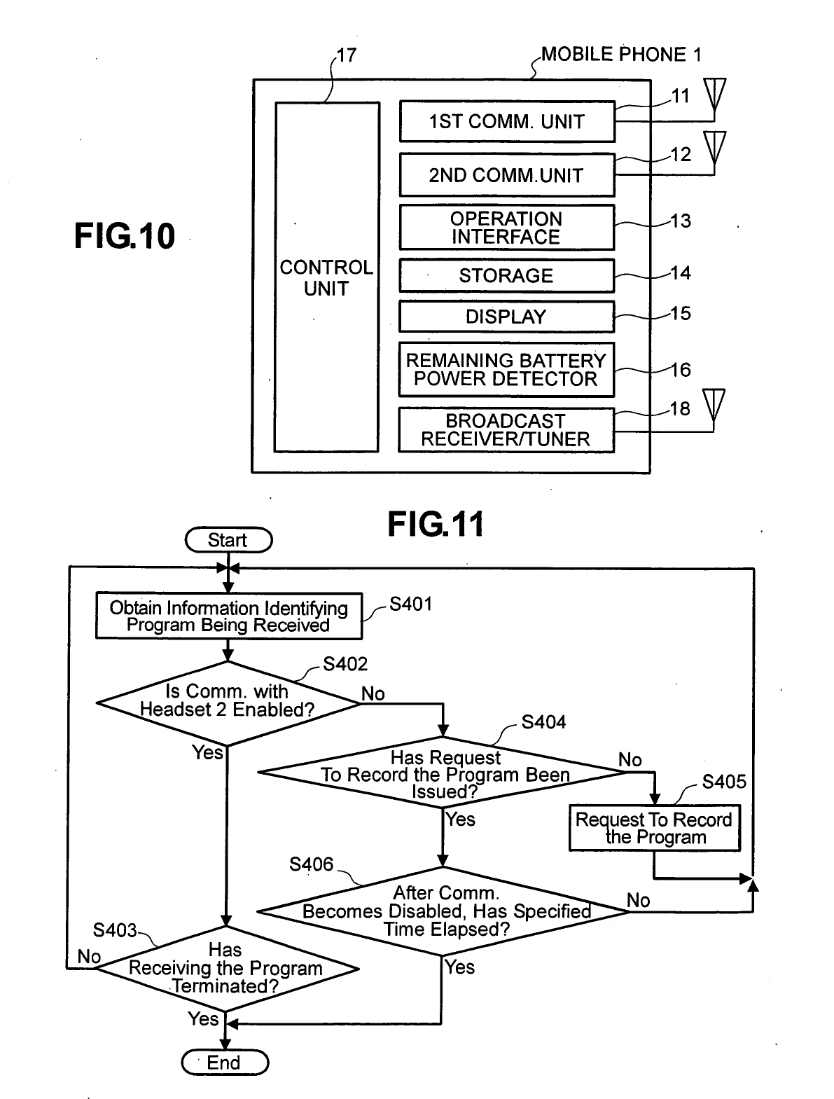

FIG. 10 shows a block diagram of the mobile phone 5 of Embodiment 3. The mobile phone 5 is made up of components corresponding to those of the mobile phone 1 with the addition of a broadcast receiver 18.

The broadcast receiver 18 receives a broadcast transmitted from a broadcasting station. The exemplary mobile phone configuration of FIG. 10 may be modified such that the communication channels of the first communication unit 11 and the second communication unit 12 are used for receiving a broadcast and other communications in parallel and the mobile phone dispenses with the separate broadcast receiver 18.

The control unit 17 in Embodiment 3 controls the components from the first communication unit 11 to the remaining battery power detector 16 and the broadcast receiver 18.

Now, an example of a processing flow that is performed by the mobile phone of Embodiment 3 is described. FIG. 11 explains how the mobile phone 5 carries out a procedure where its user receives a broadcast program and requests the server 6 to record the program. When the user of the mobile phone 5 causes the mobile phone 5 start receiving a broadcast by operating its operation interface 13, the procedure starts and goes to step S401.

In step S401, from the broadcast received by the broadcast receiver 18, the control unit 17 obtains information identifying the program being received, and the procedure goes to step S402. The information identifying the program being received may be any information that can identify the program being received, such as, for example, “date/time and program name.”

In step S402, the control unit 17 determines whether communication with the headset 2 is enabled. This determination is made in the same manner as described in Embodiment 1. However, audio information that is sent from the mobile phone 1 to the headset 2 is broadcast audio information, not audio streams. By this determination, if the communication is disabled, then the procedure goes to step S404. If the communication is enabled, then the procedure goes to step S403.

In step S404, the control unit 17 checks to see whether a request to record the program has been issued. If the request has been issued, then the procedure goes to step S406. If not, then the procedure goes to step S405.

In step S405, the control unit 17 sends a request to record the program to the server 6 through the second communication unit 12 and the procedure returns to step S401.

In step S403, the control unit 17 checks to see whether receiving the program has terminated. If not, then the procedure returns to step S401. If so, the procedure terminates.

In step S406, the control unit 17 checks to see whether specified time has elapsed after the communication between the mobile phone 1 and the headset 2 has become disabled. If the specified time has not elapsed, then the procedure returns to step S401. If the specified time has elapsed, then the procedure terminates.

The above-described capabilities and functions of the mobile phone in Embodiments 1 through 3 are implemented in software. The software programs corresponding to the functions may be retrieved from a recording medium such as a CD-ROM or downloaded from a server and the functions can be implemented on the mobile phone or other portable electronic device. Therefore, only selected functions may be installed or different functions may be added, uninstalled, or updated easily according to user preference. The present invention may be embodied in other forms by combining the above-described embodiments. Accordingly, the present invention is not limited to the above-described embodiments, and its concept and features may be used in many different technical settings.

1. A handheld electronic device configured to be operated while being held on a user's hand, the device comprising:
a first communication unit configured to transmit first data signals to a portable electronic device via a first communication link, the portable electronic device being configured to receive the first data signals from the handheld electronic device and generate sounds or images;
a second communication unit configured to receive second data signals from a remote communication device via a second communication link, wherein the first data signals transmitted to the portable electronic device are generated using the second data signals received from the remote communication device; and
a control unit configured to monitor a communication condition between the first communication unit and the portable electronic device as data signals are being received from the remote communication device via the second communication link,
wherein termination of the second communication link is initiated if the communication condition is determined to be unsatisfactory.

2. The handheld electronic device of claim 1, wherein the first data signals and the second data signals are substantially the same.

3. The handheld electronic device of claim 1, wherein the portable electronic device is an audio device, the first data signals being audio signals, and the second data signals including both audio and video signals.

4. The handheld electronic device of claim 3, wherein the audio device is a headset or includes an earphone

5. The handheld electronic device of claim 1, wherein the remote communication device is a content distribution server or a relay station coupled to the content distribution server.

6. The handheld electronic device of claim 1, wherein the remote communication device is a server and the control unit is configured to send a request to the server to stop transmitting the data signals to the second communication unit if the communication condition is determined to be unsatisfactory.

7. The handheld electronic device of claim 1, wherein the remote communication device is a server and the control unit is configured to cause the second communication unit from stop receiving the data signals from the server if the communication condition is determined to be unsatisfactory.

8. The handheld electronic device of claim 1, wherein the handheld electronic device is a mobile telephone or a personal digital assistant.

9. The handheld electronic device of claim 1, wherein the communication condition is determined to be unsatisfactory if the first communication link is terminated.

10. The handheld electronic device of claim 1, wherein the portable electronic device is battery power operated, wherein the communication condition is determined to be unsatisfactory if the battery power remaining on the portable electronic device is less than a given value.

11. The handheld electronic device of claim 1, wherein the remote communication device includes a recording device and the control unit sends a request to the remote communication device to record data signals to be transmitted to the second communication unit if the communication condition is determined to be unsatisfactory

12. The handheld electronic device of claim 1, wherein the handled electronic device is configured to provide a telephone call and the control unit sends a request signal to the remote communication device to disconnect the telephone call if the communication condition is determined to be unsatisfactory.

13. The handheld electronic device of claim 1, wherein the control unit is configured to reinitiate the second communication link between the remote communication device and the second communication unit if the communication condition between the portable electronic device and the first communication is subsequently determined to be satisfactory.

14. The handheld electronic device of claim 1, wherein portable electronic devices includes a display area to display an image generated using the first data signals received from the handheld electronic device, the portable electronic device being configured to receive power from an external power source.

15. The handheld electronic device of claim 1, wherein the second data signals are broadcast signals relating to a program, wherein the handheld device is configured to send a request to the remote server to record the program at a remote server side if the communication condition between the first communication unit and the portable electronic device is determined to be unsatisfactory.

16. An portable electronic device configured to receive broadcast signals, the device comprising:
a first communication unit which transfers broadcast signals received from a broadcast station to another portable electronic device, the received broadcast signals relating to a program;
a second communication unit configured to communicate with a remote server; and
a control unit which performs a procedure for detecting communication condition between the first communication unit and the another portable electronic device,
wherein a request is sent to the remote server to record the program at a remote server side if the communication condition is determined to be unsatisfactory.

17. The portable electronic device of claim 16, wherein the portable electronic device is a handheld device, wherein the determination of the communication condition is performed while the broadcast signals are being received by the portable electronic device.

18. A communication system, comprising:
a handheld device including a communication interface to communicate with an external device and a processor to control operations of the handheld device;
a portable electronic device configured to receive first data signals from the handheld device,
means for receiving second data signals from a remote communication device, the second data signals being received by the handheld device;
means for transmitting the first data signals from the handheld device to the portable electronic device, the first data signals being generated using the second data signals received from the remote communication device;
means for determining communication condition between the handheld device and the portable electronic device while the second data signals are being received by the handheld device; and
means for performing a predefined action if the communication condition is determined to be unsatisfactory.

19. A method for operating a handheld device configured to be operated while being held on a user's hand, the method comprising:
receiving first data signals from a remote communication device;
transmitting second data signals to a portable electronic device, the second data signals being generated using the first data signals;
determining communication condition between the handheld device and the portable electronic device while the first data signals are being received from the remote communication device; and
performing a predefined action if the communication condition between the handheld device and the portable electronic device is determined to be unsatisfactory.

20. The method of claim 19, wherein the first data signals and the second data signals are substantially the same.

21. The method of claim 19, wherein the first data signals includes audio and video signals and the second data signals correspond to the audio signals of the first data signals.

22. The method of claim 19, wherein the predefined action involves terminating a communication link between the remote communication device and the handheld device, so that the first data signals would not be received by the handheld device.

23. The method of claim 19, wherein the first data signals relate to a program, and the predefined action involves sending a request to a remote server to record the program, so that the recorded program may be viewed or listen to at a later time by a user.
